(19) United States
(12) Patent Application Publication
(10) Pub. No.: US 2014/0237018 A1
(43) Pub. Date: Aug. 21, 2014

(54) TRACKING DISTRIBUTED EXECUTION ON ON-CHIP MULTINODE NETWORKS WITHOUT A CENTRALIZED MECHANISM

(71) Applicants: Matteo Monchiero, San Francisco, CA (US); Javier Carretero Casado, Barcelona (ES); Enric Herrero, Cardedeu (ES); Tanausu Ramirez, Barcelona (ES); Xavier Vera, Barcelona (ES)

(72) Inventors: Matteo Monchiero, San Francisco, CA (US); Javier Carretero Casado, Barcelona (ES); Enric Herrero, Cardedeu (ES); Tanausu Ramirez, Barcelona (ES); Xavier Vera, Barcelona (ES)

(21) Appl. No.: 13/993,313

(22) PCT Filed: Dec. 23, 2011
(86) PCT No.: PCT/US11/67270

§ 371 Date: Jun. 11, 2013

(51) Int. Cl. H04L 12/24

(52) U.S. Cl. CPC H04L 41/046
USPC 709/202

(57) ABSTRACT

A method and system for tracking distributed execution on on-chip multinode networks, the method comprising: initiating, by a first node coupled to an on-chip network, execution of instructions on the first node for a distributed agent; initiating, by the first node, execution of instructions on a second node coupled to the on-chip network for the distributed agent; initiating, by the second node, execution of instructions on a third node coupled to the on-chip network for the distributed agent, wherein the second node does not notify the first node of the initiated execution on the third node; providing reoccurring notification by the second and third nodes to all nodes coupled to the on-chip network that they continue to execute instructions for the distributed agent; and determining, by the first node, that execution of instructions for the distributed agent is complete by detecting an absence of reoccurring notifications from nodes the network.

### FIELD

Embodiments of the invention relate generally to the field of distributed execution, and more particularly to tracking distributed execution on on-chip multinode networks.

### BACKGROUND

On-chip multinode networks may be used to perform distributed execution. For example, a service may use multiple cores of a multicore processor to execute instructions.

Typically, a centralized structure is used to keep track of distributed execution on different nodes. For example, a central structure for tracking which nodes are hosting computation, and a protocol based on acknowledgements to understand when nodes complete computations may be needed to track a distributed computation. Such centralized structures may be complex, require significant chip area, and lack scalability. Furthermore, relying on a centralized structure can result in having a single point of failure to bring system down.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is flow diagram of an arbitration flow to obtain exclusive ownership of a distributed agent by a core according to one embodiment.

FIG. 2 is a block diagram of an “acquisition ring” for arbitration to obtain exclusive ownership of a resource by a core according to one embodiment.

FIG. 3 is a block diagram of a mechanism for tracking distributed execution without a centralized structure according to one embodiment.

FIG. 4 is a flow diagram of a method for arbitrating a distributed agent including tracking distributed execution for the distributed agent according to one embodiment.

FIG. 5 is a flow diagram of a method of determining whether distributed computation is complete according to one embodiment.

FIG. 6 is a flow diagram of a method of providing notification of continued execution for a distributed agent according to one embodiment.

FIG. 7 is a block diagram of a node with logic to enable tracking of distributed execution without centralized structures.

FIG. 8 is a block diagram of an embodiment of a computing system with a multicore processor in which embodiments of the invention may operate, be executed, integrated, and/or configured.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of the invention provide for a method, apparatus, and system for tracking distributed execution on on-chip multinode networks without relying on a centralized structure. An on-chip multinode network is a plurality of interconnected nodes on one or more chips. For example, the cores of a multicore processor could be organized as an on-chip multinode network.

More than one node of a multinode network may execute instructions for an agent (i.e., for a distributed agent). A distributed agent is firmware, software, and/or hardware that implements one or more services. A distributed agent may present a single interface to the nodes of a multinode network, but is implemented in a distributed way across multiple nodes (i.e., the distributed agent implements the services using more than one node). Examples of services that may be implemented as distributed agents are services using tree-like computations. In the case of services using tree-like computations, a node starts a computation and spawns computation on other nodes, which may also spawn computation on other nodes. “Spawning” computation or execution of instructions by a first node on a second node means initiating the execution of instructions by the first node on the second node; the first node may or may not continue to also execute instructions.

Another example of a distributed agent is diagnostic services, which may be invoked on demand by a requesting node, and which may need to inspect a plurality of nodes. Similarly, optimization services such as power management or traffic management may be implemented as distributed agents.

Although a distributed agent may be implemented using more than one node to execute instructions, the distributed agent may require that only a single node have ownership of the distributed agent. For example, a distributed agent may have limited resources requiring limited access by nodes. Such access may be limited by requiring exclusive ownership of the distributed agent by a node and arbitrating amongst requesting nodes to select an owner node. While a node has exclusive ownership of a distributed agent, no other nodes may obtain ownership of the distributed agent. When an owner node is done with the distributed agent (e.g., execution for the distributed agent is complete), the owner node releases ownership so that a different requesting node may obtain ownership.

Distributed execution for a distributed agent may need to be tracked, for example, to determine when all nodes complete execution. In one embodiment of the invention, all nodes that are executing instructions for the distributed agent provide reoccurring notifications to all nodes coupled to the on-chip network while they continue to execute instructions. In one such embodiment, the owner node detects whether there are any nodes providing reoccurring notifications regarding continued execution for the distributed agent. In one embodiment, when the owner node detects that there have been no reoccurring notifications regarding continued execution for the distributed agent for a predetermined amount of time, the owner node releases ownership of the distributed agent. The distributed agent is then available for another requesting node.

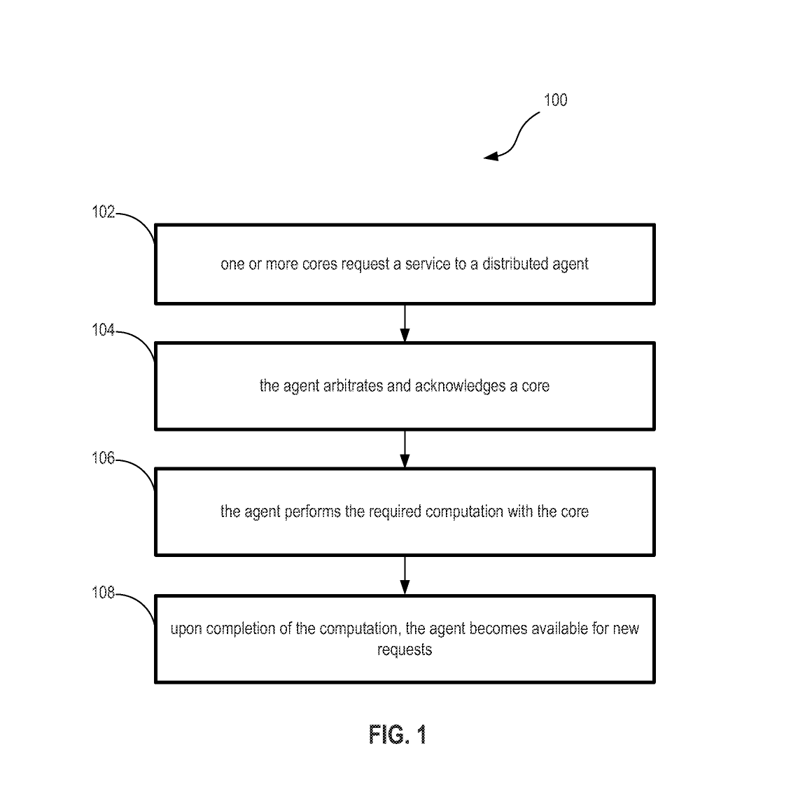

FIG. 1 is a flow diagram 100 of an arbitration flow to obtain exclusive ownership of a distributed agent by a core according to one embodiment. Arbitration for exclusive ownership over a distributed agent is one example of when distributed execution may need to be tracked.

In one embodiment, the arbitration flow begins at block 102 when one or more cores request a service to a distributed agent. At block 104, the distributed agent arbitrates and acknowledges a core (i.e., a core has won the arbitration and acquires the distributed agent to become its owner temporarily).

At block 106, the agent performs some distributed computation (e.g., implementing the requested service) starting from the owner core. In one embodiment, computation is distributed to other cores. Finally, the computations terminate and at block 108, the distributed agent becomes available for a new request.

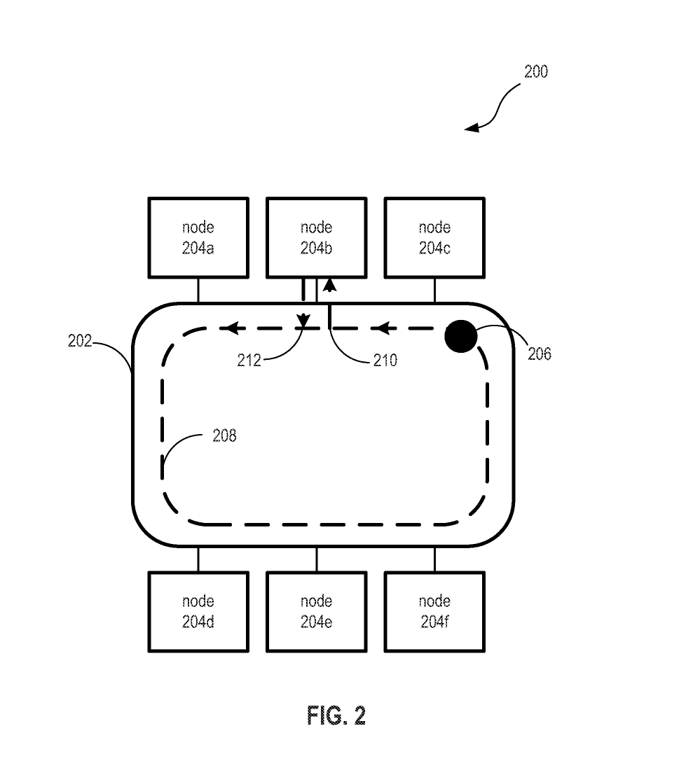

FIG. 2 is a block diagram 200 of a mechanism used in the arbitration flow described in FIG. 1 according to one embodiment. In one embodiment, the mechanism for managing exclusive ownership includes a closed-ended interconnect 202 (e.g., a ring), to which all nodes on an on-chip network are coupled (e.g., nodes 204a-204f). In one embodiment, when an agent is available, a token 206 is circulated on ring 202 and is available to be grabbed by nodes 204a-204f. For example, a token at node 204c at cycle X, if not acquired by node 204c, will reach node 204b at cycle X+1. The token can be propagated by any node by driving ring 202 according to these rules, and all nodes 204a-204f monitor the ring 202.

In this example, token 206 circulates on ring 202 (illustrated by dashed-line path 208), and is grabbed by node 204b (illustrated by arrow 210). In one embodiment, node 204b becomes the owner of the agent by grabbing token 206 off the ring 202. In one such embodiment, while node 204b has ownership of the agent, token 206 will not be circulated on ring 202.

Once node 204b obtains ownership of the agent, node 204b may initiate execution for the agent, which may include initiating execution on one or more of nodes 204a-204f. Once node 204b is done with the agent (e.g., execution for the agent is complete), node 204b may release ownership of the agent by circulating token 206 on the ring 202 (illustrated by arrow 212). Once token 206 is again circulating on ring 202, the agent is available for other requesting nodes.

Block diagram 200 illustrates one mechanism for arbitration, but embodiments of the invention may be implemented in conjunction with other arbitration schemes, or any other situation in which distributed execution needs to be tracked.

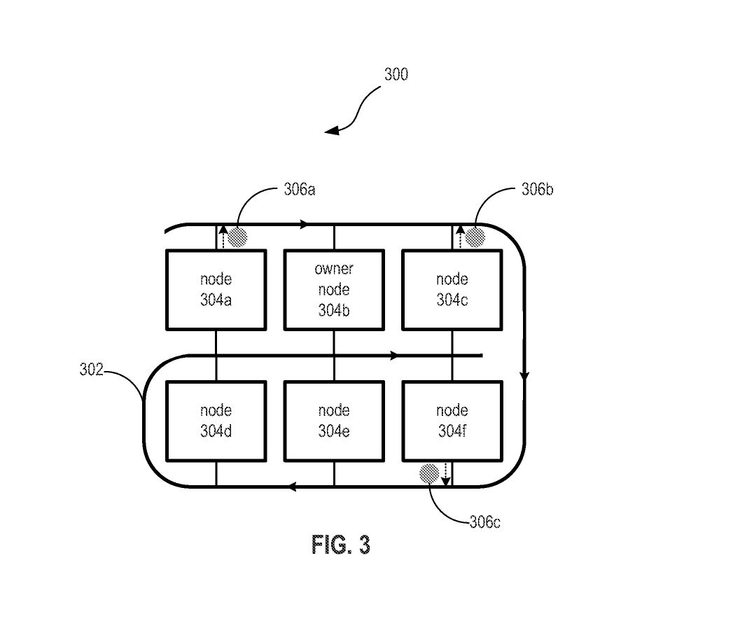

FIG. 3 is a block diagram 300 of a mechanism for tracking distributed execution without a centralized structure according to one embodiment.

In one embodiment, a mechanism for tracking distributed execution without a centralized structure includes an open-ended link 302 that couples with nodes 304a-304f on the on-chip network. As described above, a mechanism for tracking distributed execution may be used in conjunction with arbitration for distributed agents. For example, in block diagram 300, owner node 304b has ownership of a distributed service. Node 304b initiates execution of instructions on other nodes on the on-chip network, e.g., nodes 304a and 304c. One of those nodes, e.g., node 304a, initiates execution on additional nodes, e.g., node 304f. Node 304a may have initiated execution on node 304f without notifying owner node 304b. Thus, owner node 304b may not be aware of all the nodes involved in execution for the distributed service. In this example, no centralized structure is keeping track of which nodes own the distributed service, nor which nodes are executing instructions for the service, according to one embodiment.

Owner node 304b must wait until execution for the distributed agent has completed before releasing ownership. Different nodes may complete execution at different times, and owner node 304b must wait until the last node has terminated execution to release ownership.

In one embodiment, nodes 304a, 304c, and 304f provide reoccurring notifications to all nodes 304a-304f coupled to the link 302 that they continue to execute instructions for the distributed agent. In one embodiment, nodes 304a, 304c, and 304f continue providing notifications while they execute instructions, and cease to provide notifications once they have completed execution for the distributed agent. According to one embodiment, providing reoccurring notifications to all nodes coupled to link 302 by nodes 304a, 304c, and 304f includes periodically propagating a token (e.g., tokens 306a-306c) on the link. Periodically propagating a token by a node could include, e.g., driving link 302 every x cycles while the node continues to execute instructions for the distributed service, where x is a finite integer.

In one embodiment, link 302 is configured as a spiral that couples with each node twice. In one such embodiment, the spiral link 302 is pipelined and propagates tokens from node to node. Coupling with each node twice enables the owner node 304b to detect a token from any node coupled with the link 302. Because the link 302 is open-ended, propagated tokens (e.g., 306a-306c) will expire once they reach the end of the link. Other embodiments may include links having different configurations that enable nodes that are executing instructions for a distributed agent to notify all other nodes on the on-chip network that they continue to execute for the agent.

In one embodiment, the owner node 304b monitors the ring 302 to determine whether any nodes on the on-chip network continue to execute instructions for the distributed agent. According to one embodiment, because nodes 304a, 304c, and 304f will all propagate tokens on link 302 while they are executing instructions for the distributed agent, owner node 304b does not need to know specifically which nodes are involved in execution for the distributed agent. No centralized structure is needed to keep track of which node owns the distributed agent and which nodes are executing for the agent. Once the owner node 304b determines that execution for the distributed agent is complete (e.g., by detecting that no tokens have been circulated on the link 302 for a predefined period of time), owner node 304b can release ownership of the distributed agent.

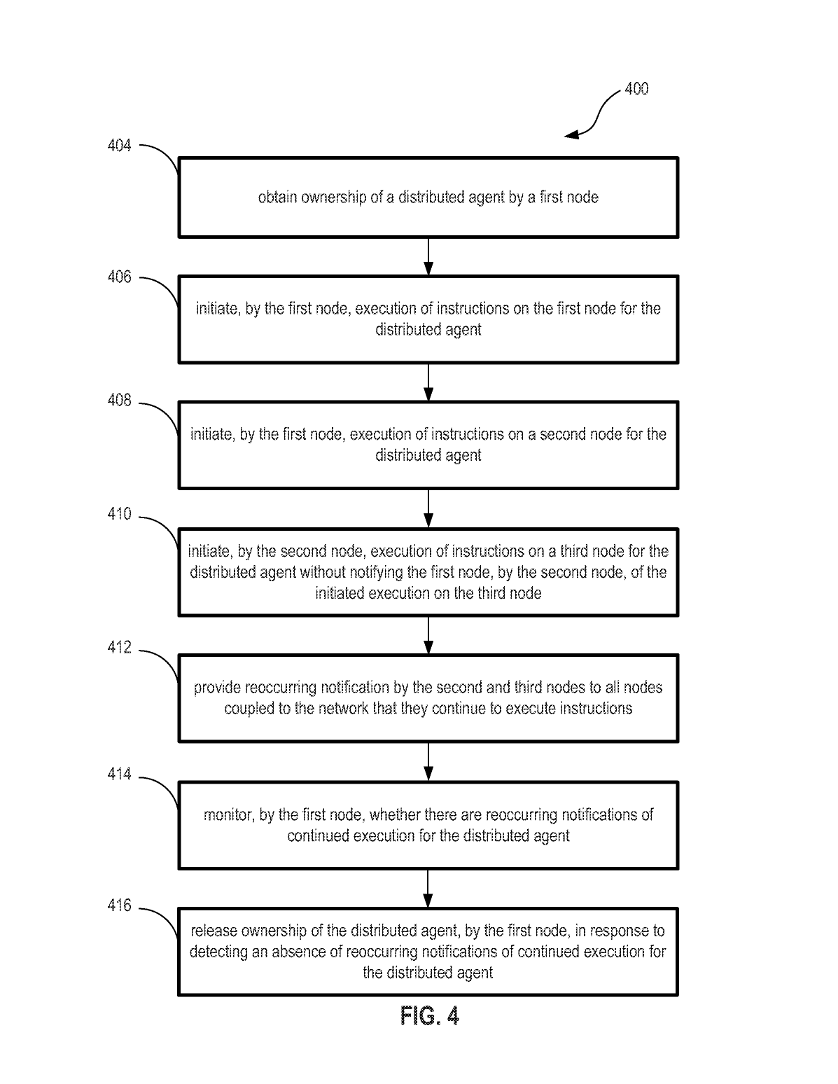

FIG. 4 is a flow diagram 400 of a method for arbitrating a distributed agent including tracking distributed execution for the distributed agent according to one embodiment. Flow diagram 400 begins at block 404 when a first node obtains ownership of a distributed agent. Obtaining ownership may be accomplished via arbitration as discussed with reference to FIGS. 1 and 2.

After obtaining ownership of a distributed agent, the first node can initiate the execution of instructions for the distributed agent at block 406. At block 408, the first node initiates the execution of instructions on a second node. The second node then initiates execution of instructions on a third node for the distributed agent without notifying the first node at block 410.

At block 412, the second and third nodes provide reoccurring notifications to all nodes coupled to the network that they continue to execute instructions for the distributed agent. The reoccurring notifications may be, for example, tokens on a link as described with reference to FIG. 3.

At block 414, the first node (i.e., the owner node), monitors whether any nodes are providing reoccurring notifications of continued execution for the distributed agent. In response to detecting an absence of reoccurring notifications of continued execution for the distributed agent, the first node releases ownership of the distributed agent at block 416.

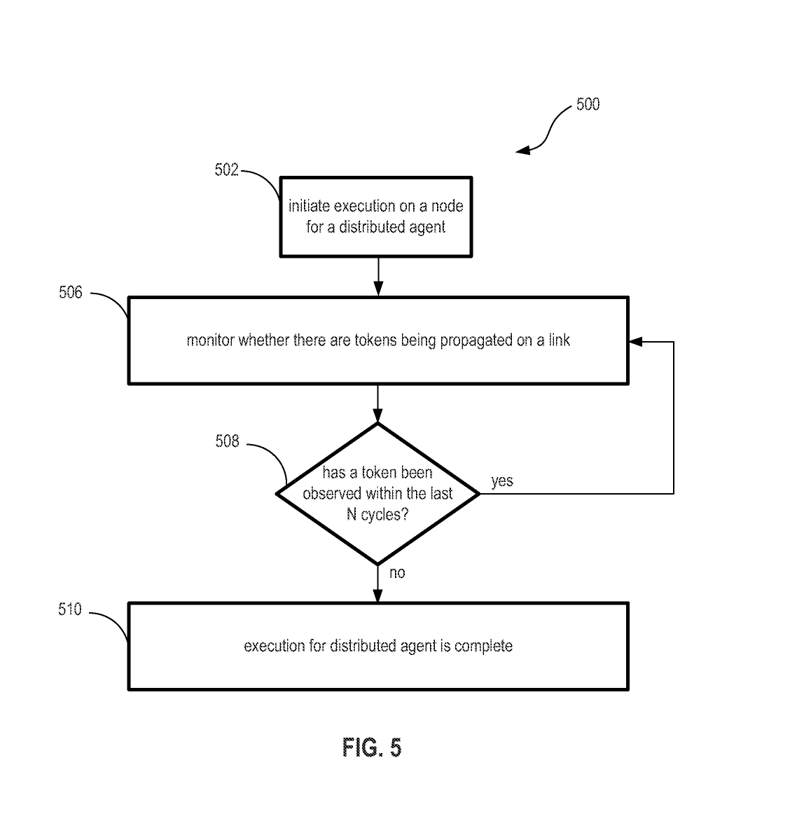

FIG. 5 is a flow diagram 500 of a method of determining whether distributed computation is complete according to one embodiment. Flow diagram 500 is from the perspective of, for example, an owner node (e.g., the first node described in reference to FIG. 4). At block 502, an owner node initiates execution on a node for a distributed agent. At block 506, the owner node monitors whether there are tokens being propagated on a link (e.g., link 302 in FIG. 3).

At decision block 508, the owner node determines whether a token has been observed within the last N cycles, where N is, for example, twice the number of cycles that a packet takes to circulate on the link. In one embodiment, N=2M where M is the number of nodes coupled to the link, and a hop from node to node is 1 (e.g., the propagation time of a token from one node to the next is 1). If a token has been observed within the last N cycles, the owner node continues to monitor the link.

Finally, if no tokens are observed within the last N cycles, the owner node determines that execution for the distributed agent is complete at block 510. Once the owner node determines that execution is complete, owner node can release ownership of the distributed agent.

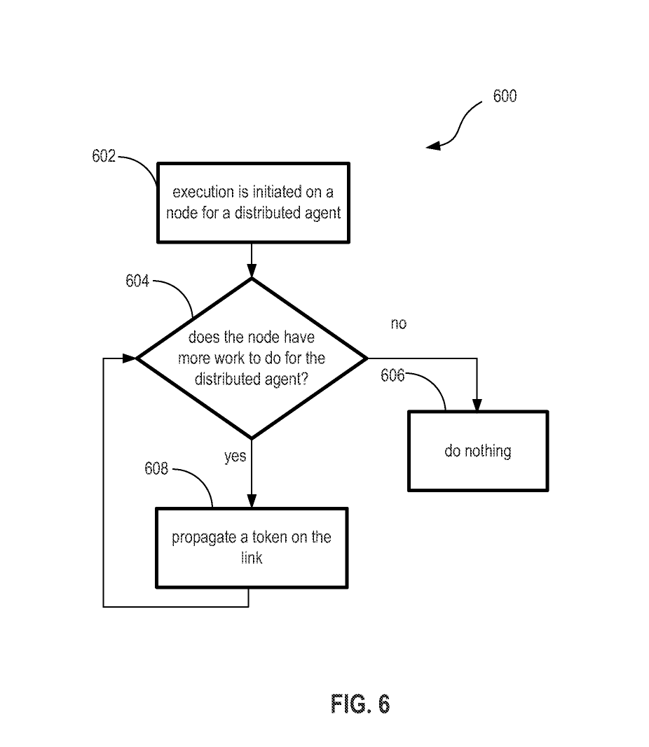

FIG. 6 is a flow diagram 600 of a method of providing notification of continued execution for a distributed agent according to one embodiment. Flow diagram 600 is from the perspective of a node that is performing execution for a distributed agent (e.g., the second and third nodes described in reference to FIG. 4).

At block 602, execution is initiated on a node for a distributed agent (by, for example, the owner node described in reference to FIG. 4). At decision block 604, the node determines whether it has more work to do for the distributed agent (e.g., whether the node has further instructions to execute for the distributed agent). If the node has more work to do, the node propagates a token on the link at block 608 (e.g., the link referred to in block 506 of FIG. 5). After propagating a token on the link, the node continues to determine whether it has more work to do for the distributed agent at decision block 604. If the node does not have more work to do for the distributed agent (e.g., the node has completed execution for the agent), the node ceases to propagate tokens on the link at block 606.

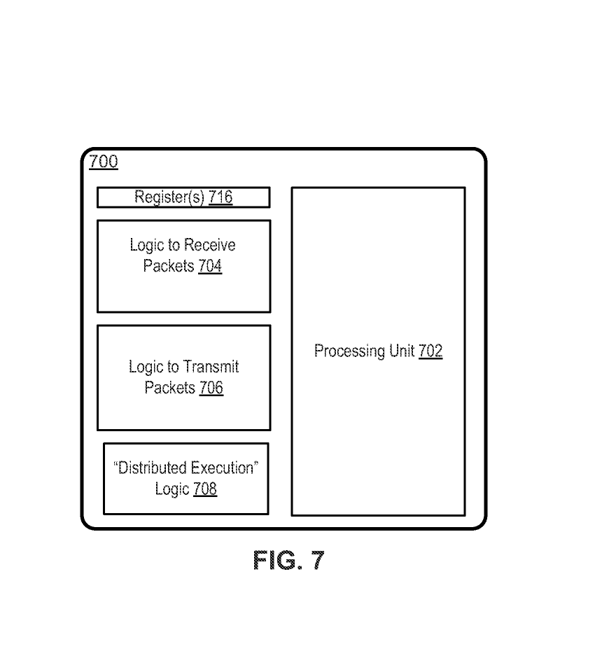

FIG. 7 is a block diagram of a node with logic to enable tracking of distributed execution without centralized structures. In one embodiment, node 700 is a core of a multicore processor and includes processing unit 702 for executing instructions (e.g., instructions for a distributed agent). In one embodiment, node 700 further includes logic 704 to receive packets, logic 706 to transmit packets, “distributed execution” logic 708, and register(s) 716.

In one embodiment, “distributed execution” logic 708 includes logic for monitoring a link (e.g., link 302 in FIG. 3) to which node 700 is coupled. Logic for monitoring the link would be used, for example, if node 700 has exclusive ownership over a distributed agent, and needs to determine when distributed execution for the distributed agent is complete. In one such embodiment, monitoring the link may include monitoring the link for tokens which indicate that a node continues to execute instructions for the distributed agent.

According to one embodiment, “distributed execution” logic 708 also includes logic for asserting the link (e.g., propagating a token) in response to determining that node 700 continues to execute instructions for the distributed agent.

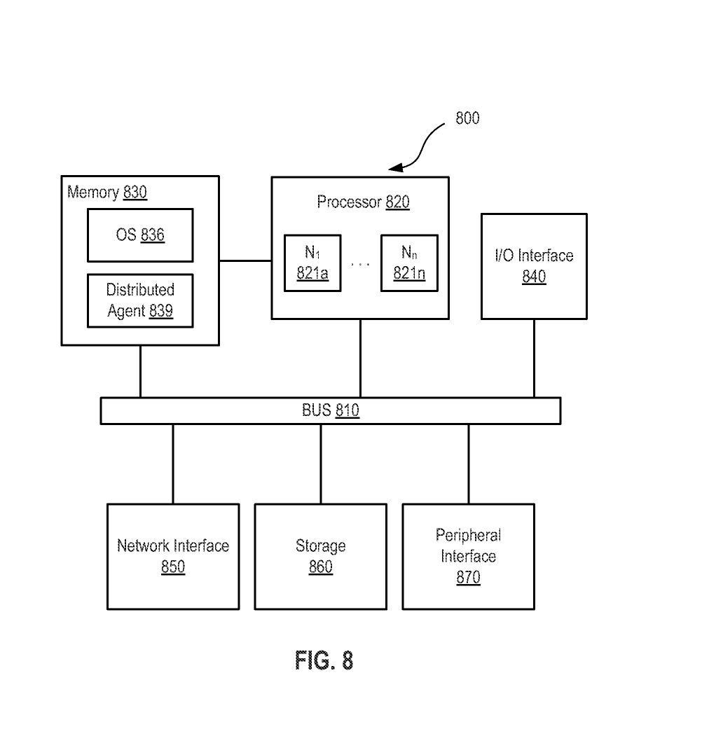

FIG. 8 is a block diagram of an embodiment of a computing system with a multicore processor in which embodiments of the invention may operate, be executed, integrated, and/or configured.

System 800 represents a computing device, and can be a laptop computer, a desktop computer, a server, a gaming or entertainment control system, a scanner, copier, printer, a tablet, or other electronic device. System 800 includes processor 820, which provides processing, operation management, and execution of instructions for system 800. Processor 820 can include any type of processing hardware having multiple processor cores 821a-821n to provide processing for system 800. Processor cores 821a-821n are organized as an interconnected on-chip network. Processor cores 821a-821n include logic to enable tracking of distributed execution without centralized structures. Embodiments of the invention as described above may be implemented in system 800 via hardware, firmware, and/or software.

Memory 830 represents the main memory of system 800, and provides temporary storage for code to be executed by processor 820, or data values to be used in executing a routine. Memory 830 may include one or more memory devices such as read-only memory (ROM), flash memory, one or more varieties of random access memory (RAM), or other memory devices, or a combination of such devices. Memory 830 stores and hosts, among other things, operating system (OS) 836 to provide a software platform for execution of instructions in system 800 and instructions for a distributed agent 839. OS 836 and instructions for the distributed agent 839 are executed by processor 820.

Processor 820 and memory 830 are coupled to bus/bus system 810. Bus 810 is an abstraction that represents any one or more separate physical buses, communication lines/interfaces, and/or point-to-point connections, connected by appropriate bridges, adapters, and/or controllers. Therefore, bus 810 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 810 can also correspond to interfaces in network interface 850.

In one embodiment, bus 810 includes a data bus that is a data bus over which processor 820 can read values from memory 830. The additional line shown linking processor 820 to memory subsystem 830 represents a command bus over which processor 820 provides commands and addresses to access memory 830.

System 800 also includes one or more input/output (I/O) interface(s) 840, network interface 850, one or more internal mass storage device(s) 860, and peripheral interface 870 coupled to bus 810. I/O interface 840 can include one or more interface components through which a user interacts with system 800 (e.g., video, audio, and/or alphanumeric interfacing). Network interface 850 provides system 800 the ability to communicate with remote devices (e.g., servers, other computing devices) over one or more networks. Network interface 850 can include an Ethernet adapter, wireless interconnection components, USB (universal serial bus), or other wired or wireless standards-based or proprietary interfaces.

Storage 860 can be or include any conventional medium for storing data in a nonvolatile manner, such as one or more magnetic, solid state, or optical based disks, or a combination. Storage 860 may hold code or instructions and data in a persistent state (i.e., the value is retained despite interruption of power to system 800). Storage 860 may include a non-transitory machine-readable or computer readable storage medium on which is stored instructions (e.g., software and/or firmware) embodying any one or more of the methodologies or functions described herein.

Peripheral interface 870 can include any hardware interface not specifically mentioned above. Peripherals refer generally to devices that connect dependently to system 800. A dependent connection is one where system 800 provides the software and/or hardware platform on which operation executes, and with which a user interacts. Besides what is described herein, various modifications can be made to the disclosed embodiments and implementations of the invention without departing from their scope. Therefore, the illustrations and examples herein should be construed in an illustrative, and not a restrictive sense. Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed. The scope of the invention should be measured solely by reference to the claims that follow.

What is claimed is:

1. A method comprising:
initiating, by a first node coupled to an on-chip network, execution of instructions on the first node, wherein the execution of instructions on the first node is for a distributed agent;
initiating, by the first node, execution of instructions on a second node coupled to the on-chip network, wherein the execution of instructions on the second node is for the distributed agent;
initiating, by the second node, execution of instructions on a third node coupled to the on-chip network, wherein the execution of instructions on the third node is for the distributed agent and wherein the second node does not notify the first node of the initiated execution on the third node;
providing reoccurring notification by the second node to all nodes coupled to the on-chip network that the second node continues to execute instructions for the distributed agent;
providing reoccurring notification by the third node to all nodes coupled to the on-chip network that the third node continues to execute instructions for the distributed agent; and
determining, by the first node, that execution of instructions for the distributed agent is complete by detecting an absence of reoccurring notifications of continued execution of instructions for the distributed agent from nodes coupled to the on-chip network.

2. The method of claim 1, further comprising:
prior to initiating execution of instructions on the first node, obtaining ownership of the distributed agent by the first node; and
releasing ownership of the distributed agent responsive to determining, by the first node, that execution of instructions for the distributed agent is complete.

3. The method of claim 1, wherein the first node, the second node, and the third node are cores of a multicore processor.

4. The method of claim 1, wherein providing reoccurring notification to all nodes coupled to the on-chip network comprises periodically propagating a token on a link, wherein all nodes coupled to the on-chip network are coupled with the link.

5. The method of claim 4, wherein the link is an open-ended link configured as a spiral that couples with each node on the on-chip network twice, and wherein coupling with each node twice enables the first node to detect a token from any node coupled with the link.

6. The method of claim 5, wherein detecting the absence of reoccurring notifications by the first node comprises detecting that a token has not been propagated for a pre-determined number of cycles.

7. The method of claim 6, wherein the pre-determined number of cycles is N, wherein N is twice a number of cycles that a token takes to pass by all nodes coupled with the link.

8. A system comprising:
a first node coupled to an on-chip network to spawn execution of instructions on a second node coupled to the on-chip network for a distributed agent, wherein the second node is to spawn execution of instructions on a third node coupled to an on-chip network for the distributed agent, and wherein the execution of instructions for the distributed agent is not tracked via a centralized structure, and wherein the first node is to determine when execution for the distributed agent is complete by observing that no node coupled to the on-chip network is providing reoccurring notifications to all nodes coupled to the on-chip network regarding continued execution;
the second node to provide reoccurring notifications to all nodes coupled to the on-chip network regarding continued execution while the second node continues to execute for the distributed agent;
the third node to provide reoccurring notifications to all nodes coupled to the on-chip network regarding continued execution while the third node continues to execute for the distributed agent.

9. The system of claim 8, wherein the first node, the second node, and the third node are cores of a multicore processor.

10. The system of claim 8, wherein providing reoccurring notification to all nodes coupled to the on-chip network comprises periodically propagating a token on a link, wherein all nodes coupled to the on-chip network are coupled with the link.

11. The system of claim 10, wherein the link is an open-ended link configured as a spiral that couples with each node on the on-chip network twice, and wherein coupling with each node twice enables the first node to detect a token from any node coupled with the link.

12. The system of claim 11, wherein observing that no node coupled to the on-chip network is providing reoccurring notifications to all nodes coupled to the on-chip network regarding continued execution comprises detecting that a token has not been propagated for a pre-determined number of cycles.

13. The system of claim 12, wherein the pre-determined number of cycles is N, wherein N is twice a number of cycles that a token takes to pass by all nodes coupled with the link.

14. An article of manufacture comprising a computer-readable storage medium having content stored thereon, which when executed causes one or more processors having nodes organized as an on-chip network to:
initiate, by a first node coupled to an on-chip network, execution of instructions on the first node, wherein the execution of instructions on the first node is for a distributed agent;
initiate, by the first node, execution of instructions on a second node coupled to the on-chip network, wherein the execution of instructions on the second node is for the distributed agent;
initiate, by the second node, execution of instructions on a third node coupled to the on-chip network, wherein the execution of instructions on the third node is for the distributed agent and wherein the second node does not notify the first node of the initiated execution on the third node;
provide reoccurring notification by the second node to all nodes coupled to the on-chip network that the second node continues to execute instructions for the distributed agent;
provide reoccurring notification by the third node to all nodes coupled to the on-chip network that the third node continues to execute instructions for the distributed agent; and
determine, by the first node, that execution of instructions for the distributed agent is complete by detecting an absence of reoccurring notifications of continued execution of instructions for the distributed agent from nodes coupled to the on-chip network.

15. The article of manufacture of claim 14, which when executed further causes one or more processors having nodes organized as an on-chip network to:
prior to initiating execution of instructions on the first node, obtain ownership of the distributed agent by the first node; and
release ownership of the distributed agent responsive to determining, by the first node, that execution of instructions for the distributed agent is complete.

16. The article of manufacture of claim 14, wherein the first node, the second node, and the third node are cores of a multicore processor.

17. The article of manufacture of claim 14, wherein providing reoccurring notification to all nodes coupled to the on-chip network comprises periodically propagating a token on a link, wherein all nodes coupled to the on-chip network are coupled with the link.

18. The article of manufacture of claim 17, wherein the link is an open-ended link configured as a spiral that couples with each node on the on-chip network twice, and wherein coupling with each node twice enables the first node to detect a token from any node coupled with the link.

19. The article of manufacture of claim 18, wherein detecting the absence of reoccurring notifications by the first node comprises detecting that a token has not been propagated for a pre-determined number of cycles.

20. The article of manufacture of claim 19, wherein the pre-determined number of cycles is N, wherein N is twice a number of cycles that a token takes to pass by all nodes coupled with the link.
